(19) United States
(12) Patent Application Publication
(10) Pub. No.: US 2005/0108190 A1
(43) Pub. Date: May 19, 2005

(54) Enterprise directory service diagnosis and repair

(76) Inventor: Dale W. Conkel, Arlington, TX (US)

Correspondence Address: Stephen R. Loe;The Law Office of Stephen R. Loe, P.O. Box 649, Frisco, TX, 75034, US

(21) Appl. No.: 10/715,059

(22) Filed: Nov. 17, 2003

(51) Int. Cl. G06F 7/00

(52) U.S. Cl. 707/1

(57) ABSTRACT

A method, system, and computer program product for monitoring a directory service within a distributed data processing system is provided. In one embodiment, the monitoring system scans the event logs of components and applications utilized by the directory service within a distributed data processing system. Responsive to a determination that an error is indicated by one of the event logs, the monitoring system consults a knowledge base to determine if an entry for the error is contained within the knowledge base. If an entry for the error is contained within the knowledge base, the system determines corrective actions to be taken to correct the error and whether the corrective actions are authorized under the present conditions of the distributed data processing system by consulting the knowledge base entries. If the corrective actions are authorized, the monitoring system commits the corrective actions to restore the directory service and distributed data processing system to proper working order.

### BACKGROUND OF THE INVENTION

1. Technical Field

The present invention relates generally to computer software and, more particularly, to an improved directory service in a distributed data processing system.

2. Description of Related Art

A directory service is the main switchboard of a network operating system. It manages the identities of various distributed resources and manages the relationships between the various resources, thus allowing the various resources to work together. The directory service is also a place to store information about enterprise assets such as applications, files, printers, and users. A directory service further provides a consistent method for naming, describing, locating accessing, managing, and securing information about the resources.

Many software applications have directory service functionality built into their applications. However, these services are narrowly targeted directory services that often lack standards-based interfaces. This often results in one network containing multiple directories that do not work together and must be maintained separately. Maintaining disparate directory services such as this often translates into increased costs for the enterprise and requires greater management and more complex applications.

To overcome these disadvantages, enterprise-class directory services have been developed, such as, for example, Microsoft Windows 2000 Server Active Directory®, which is a product and registered trademark of the Microsoft Corporation of Redmond, Wash. An enterprise-class directory service is a consolidation point for isolating, migrating, centrally managing, and reducing the number of directories found in a network. Utilizing an enterprise-class directory service can simplify management, strengthen security, and increase interoperability.

In order to provide the benefits noted above, enterprise-class directory services are, by necessity, very complex. Greater complexity implies a correspondingly greater probability of problems arising. Furthermore, because of the complexity of these enterprise-class directory services, diagnosing and solving problems as they arise are also difficult. However, the benefits, such as interoperability, outweigh the disadvantages associated with the complexity of the system. Therefore, rather than retreating to simpler application specific directory services, it would be desirable to have a computer program product, method, and system for monitoring key components of an enterprise class directory service, analyze problems, and automatically take corrective action to restart failed components.

### SUMMARY OF THE INVENTION

The present invention provides a method, system, and computer program product for monitoring a directory service within a distributed data processing system. In one embodiment, the monitoring system scans the event logs of components and applications utilized by the directory service within a distributed data processing system. Responsive to a determination that an error is indicated by one of the event logs, the monitoring system consults a knowledge base to determine if an entry for the error is contained within the knowledge base. If an entry for the error is contained within the knowledge base, the system determines corrective actions to be taken to correct the error and whether the corrective actions are authorized under the present conditions of the distributed data processing system by consulting the knowledge base entries. If the corrective actions are authorized, the monitoring system commits the corrective actions to restore the directory service and distributed data processing system to proper working order.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3 depicts a block diagram of a data processing system in which the present invention may be implemented; and

FIG. 4 depicts a diagram illustrating an exemplary process flow and program function for providing directory service monitoring in accordance with one embodiment of the present invention.

### DETAILED DESCRIPTION OF THE PREFERRED EMBODIMENT

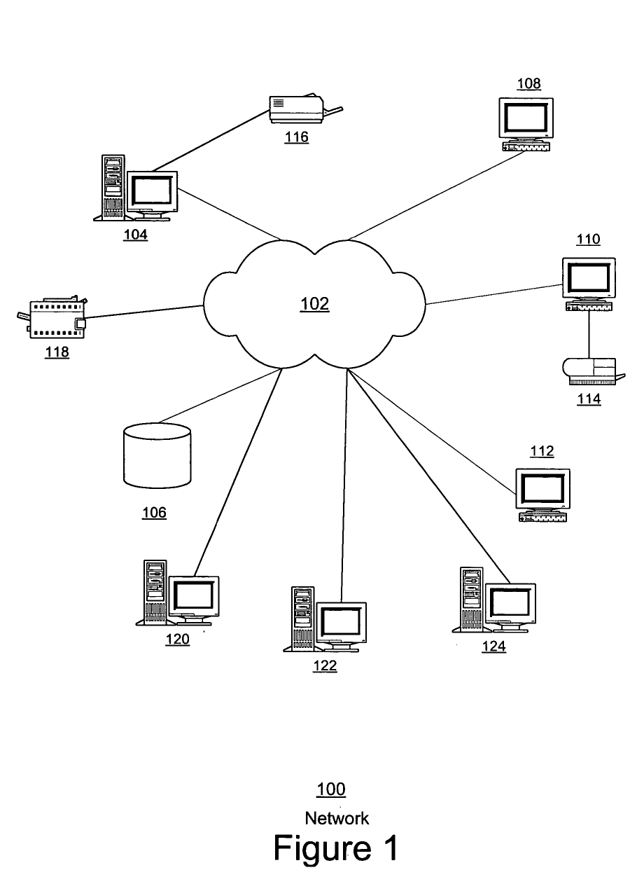

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, servers 104, 120, 122, and 124 are connected to network 102, along with storage unit 106. In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. In the depicted example, server 104 provides data, such as boot files, operating system images and applications, to clients 108-112. Server 120 is an e-mail server for users in network 100. Server 122 provides access to the Internet and provides firewall and other security services. Server 124 manages the enterprise-class directory service as well as provides directory service monitoring of at least key components within distributed data processing system 100. The directory service monitoring service will be discussed in more detail below.

Clients 108, 110 and 112 are clients to server 104. Distributed data processing system 100 may include additional servers, clients, and other devices not shown. Distributed data processing system 100 also includes printers 114, 116 and 118. A client, such as client 110, may print directly to printer 114. Clients such as client 108 and client 112 do not have directly attached printers. These clients may print to printer 116, which is attached to server 104, or to printer 118, which is a network printer that does not require connection to a computer for printing documents. Client 110, alternatively, may print to printer 116 or printer 118, depending on the printer type and the document requirements. Any one of clients 108, 110, and 112 may be used as a monitoring console by a directory services administrator to receive information about the directory service monitoring process and allow entry of commands and data by the directory service administrator.

In the depicted example, distributed data processing system 100 is the Intranet, with network 102 representing an enterprise-wide collection of networks and gateways that use a set of protocols to communicate with one another. Distributed data processing system 100 also may be implemented as a number of different types of networks such as, for example, a wide area network or a local area network.

FIG. 1 is intended as an example and not as an architectural limitation for the processes of the present invention.

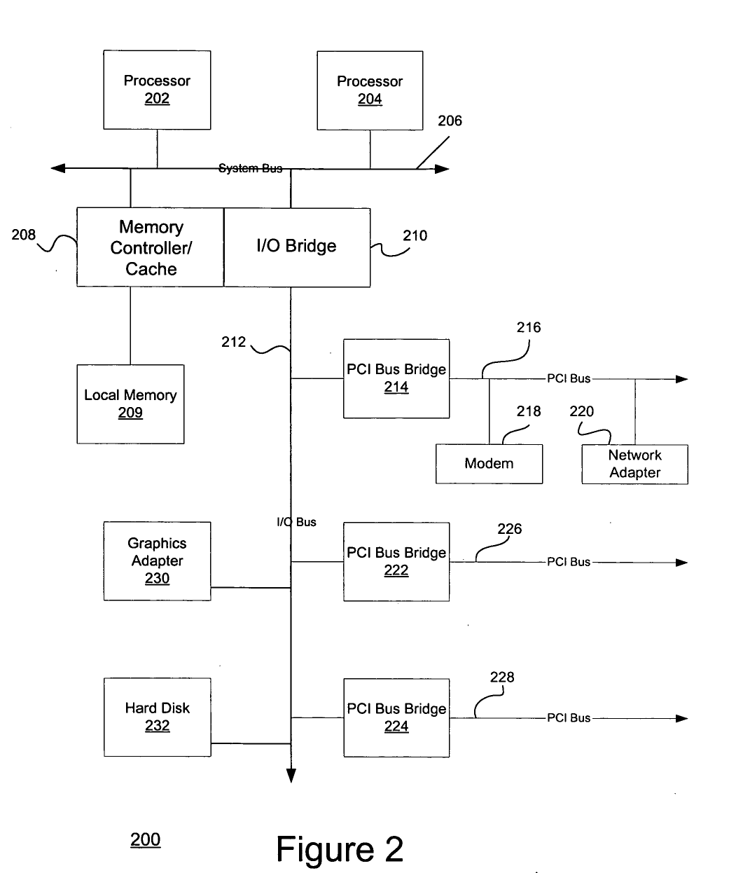

Referring to FIG. 2, a block diagram of a data processing system which may be implemented as a server, such as any one of servers 104, 120, 122, and 124 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries.

When implemented as server 124, server 200 implements instructions for monitoring the directory service components within network 100. These instructions may be stored internally, such as on hard disk 232, externally, such as on database 106, or in a combination of internal and external storage devices and are loaded into local memory 209 to be executed by one or both of processors 202 and 204. However, depending on implementation of the present invention, various subcomponents and processes may be loaded and executed on other data processing systems within network 100. For example, if client 108 is utilized as a monitoring console by a directory service administrator, various components of the directory service monitoring system may be implemented on client 108 in order to provide the directory service administrator with an interface to receive information from and input data into the directory monitoring system.

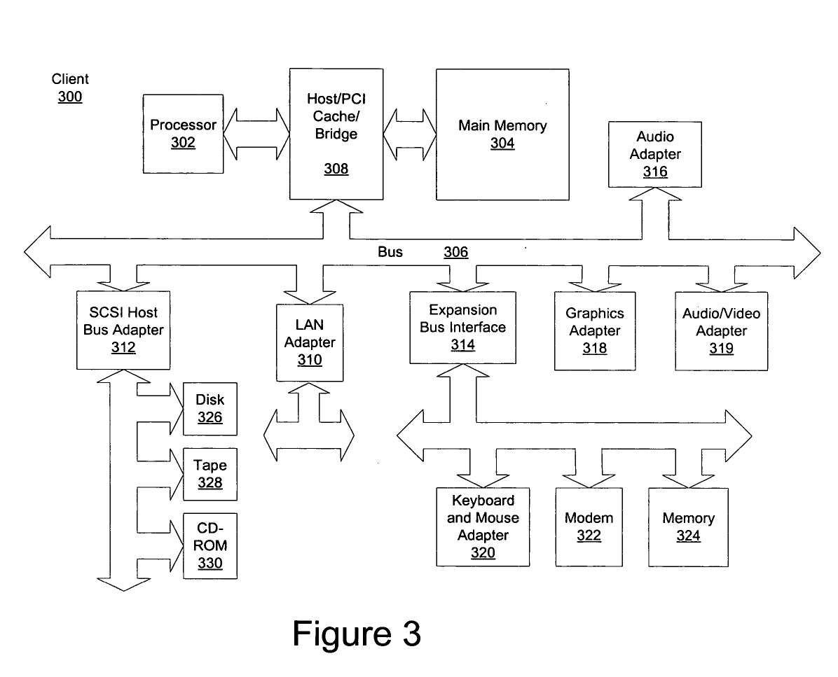

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302. When utilized as a monitoring console, various components of the directory service monitoring system necessary and sufficient to allow a directory service administrator to interface with the directory service monitoring system are loaded into main memory 304 and executed by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

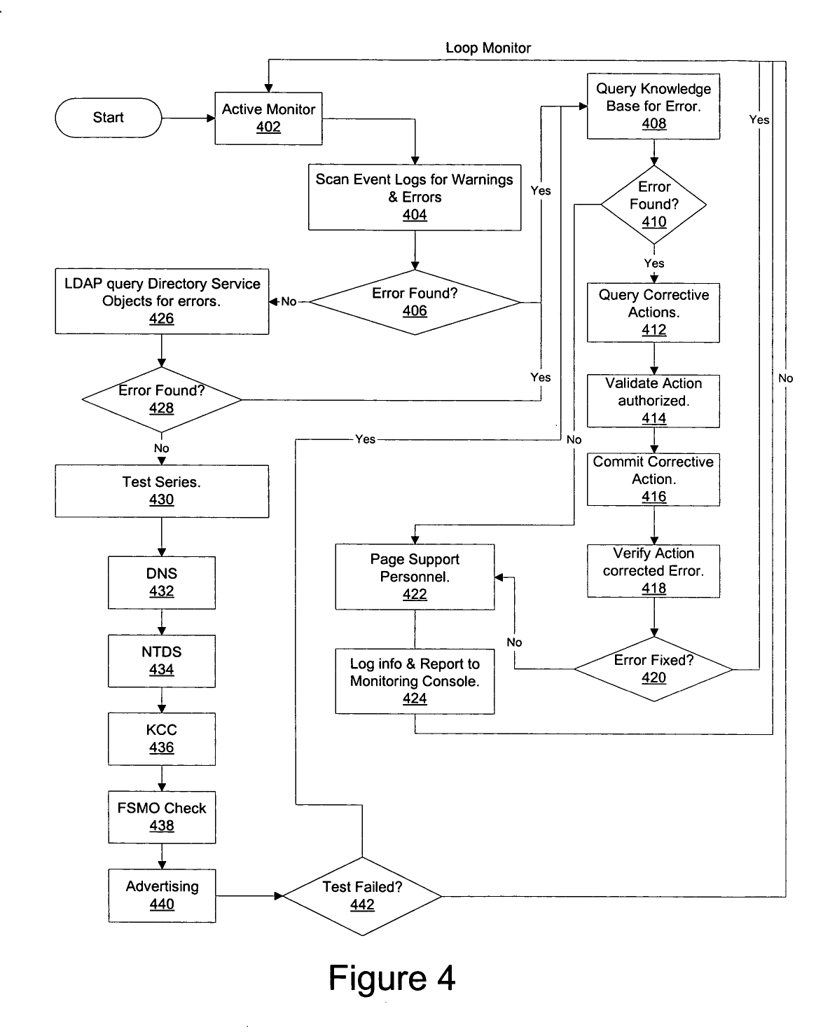

With reference now to FIG. 4, a diagram illustrating an exemplary process flow and program function for providing directory service monitoring is depicted in accordance with one embodiment of the present invention. The directory service monitoring system begins active monitoring (step 402) and scans event logs for warnings and errors (step 404). The system determines whether an error is found (step 406) and, if yes, the system queries a knowledge base for the error (step 408). The knowledge base is a database containing a listing of potential errors that may occur within the network, such as, for example, network 100, and contains a list of corrective actions corresponding to the listing of errors. The knowledge base also contains a listing of conditions necessary for the corrective action to be authorized. The knowledge base may be stored, for example, on hard disk 232 or in database 106.

The system then determines whether the error was found in the knowledge base (step 410) and, if yes, queries the knowledge base (or other database in some implementations) for a statement or determination of corrective actions necessary to correct the identified error (step 412). As new types of errors are determined, these may be added to the knowledge base along with appropriate corrective actions that will not damage the directory service or other components within the distributed data processing system. The system then validates that the action is authorized (step 414) and commits corrective action (step 416) if authorized and omits taking corrective action if the corrective action is not authorized in under the present circumstances. The system then takes actions to verify that the corrective action corrected the error (step 418) and determines whether the error is fixed (step 420). If the error is fixed, then the system continues with active monitoring of the directory service components (step 402).

If the error is not fixed by the corrective action in (step 416) or if no corrective action was performed because it was not authorized, then support personnel are paged (step 422) and the information concerning the nature, identity, and location of the report as well as any other information deemed pertinent is logged and a report is presented on a monitoring console (step 424). The support personnel may then determine what actions are necessary in order to correct the error.

Returning to step 406, if no errors or warnings are found when the event logs are scanned (step 404), then a Lightweight Directory Access Protocol (LDAP) query of the Directory service objects is performed to determine whether there are any errors (step 426). It is then determined whether any errors are found as a result of this query (step 428) and, if yes, then the system continues with step 408 as described above. If, however, no errors are found in step 428, then a test series is begun (step 430) in which various components, such as, for example, DNS 432, NTDS 434, KCC 436, FSMO Check 438, and Advertising 440 are checked to determine whether they are performing correctly. {What do the abbreviations DNS, NTDS, KCC, an FSMO stand for?} This list of components is merely provided as an example. The components checked will depend on the components a particular enterprise uses and will vary with implementation. Next, the system determines whether any of the tests failed (step 442), and if yes, continues with step 408 as described above. If the system determines that no test failed (step 442), then the system continues active monitoring of the directory service (step 402).

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for monitoring a directory service, the method comprising:
scanning event logs for components and applications utilized by a directory service within a distributed data processing system;
responsive to a determination that an error is indicated by one of the event logs, consulting a knowledge base to determine if an entry for the error is contained within the knowledge base, wherein the knowledge base contains entries for known errors and associated corrective actions;
responsive to a determination that an entry for the error is contained within the knowledge base, determining corrective actions to be taken to correct the error and determining whether the corrective actions are authorized under present conditions of the distributed data processing system; and
responsive to a determination that the corrective actions are authorized, committing the corrective actions.

2. The method as recited in claim 1, further comprising:
responsive to a determination that the corrective action is not authorized, paging support personnel;
logging relevant information related to the error; and
providing a report concerning the error to a monitoring console.

3. The method as recited in claim 1, wherein determining the corrective actions comprises consulting a table containing identified errors and associated corrective actions.

4. The method as recited in claim 1, further comprising:
responsive to a determination that the error is not found in the knowledge base, paging support personnel;
logging relevant information related to the error; and
providing a report concerning the error to a monitoring console.

5. The method as recited in claim 1, further comprising:
querying directory service objects for errors;
responsive to a determination that an error is found from querying the directory service objects for errors, consulting a knowledge base to determine whether an entry for the error is contained within the knowledge base, wherein the knowledge base contains entries for know errors and associated corrective actions;
responsive to a determination that an entry for the error is contained within the knowledge base, determining corrective actions to be taken to correct the error and determining whether the corrective actions are authorized under present conditions of the distributed data processing system; and
responsive to a determination that the corrective actions are authorized, committing the corrective actions.

6. The method as recited in claim 5, further comprising:
responsive to a determination that an error is not found after querying the directory service objects for errors, testing a component within the distributed data processing system and utilized in conjunction with the director service to determine whether the component is functioning properly;
responsive to a determination that an error exists preventing the component from functioning properly, consulting a knowledge base to determine if an entry for the error is contained within the knowledge base;
responsive to a determination that an entry for the error is contained within the knowledge base, determining corrective actions to be taken to correct the error and determining whether the corrective actions are authorized under present conditions of the distributed data processing system; and
responsive to a determination that the corrective actions are authorized, committing the corrective actions.

7. A computer program product in a computer readable medium for use in a data processing system for monitoring a directory service, the computer program product comprising:
first instructions for scanning event logs for components and applications utilized by a directory service within a distributed data processing system;
second instructions for consulting a knowledge base to determine if an entry for the error is contained within the knowledge base if it is determined that an error is indicated by one of the event logs, wherein the knowledge base contains entries for known errors and associated corrective actions;
third instructions for determining corrective actions to be taken to correct the error and determining whether the corrective actions are authorized under present conditions of the distributed data processing system if it is determined that an entry for the error is contained within the knowledge base; and
fourth instructions for committing the corrective actions if it is determined that the corrective actions are authorized.

8. The computer program product as recited in claim 7, further comprising:
fifth instructions for paging support personnel if it is determined that the corrective action is not authorized;
sixth instructions for logging relevant information related to the error; and
seventh instructions for providing a report concerning the error to a monitoring console.

9. The computer program product as recited in claim 7, wherein determining the corrective actions comprises consulting a table containing identified errors and associated corrective actions.

10. The computer program product as recited in claim 7, further comprising:
fifth instructions for paging support personnel if it is determined that the error is not found in the knowledge base;
sixth instructions for logging relevant information related to the error; and
seventh instructions for providing a report concerning the error to a monitoring console.

11. The computer program product as recited in claim 7, further comprising:
fifth instructions for querying directory service objects for errors;
sixth instructions for consulting a knowledge base to determine whether an entry for the error is contained within the knowledge base if it is determined that an error is found from querying the directory service objects for errors, wherein the knowledge base contains entries for known errors and associated corrective actions;
seventh instructions for determining corrective actions to be taken to correct the error and determining whether the corrective actions are authorized under present conditions of the distributed data processing system if it is determined that an entry for the error is contained within the knowledge base; and
eighth instructions for committing the corrective actions if it is determined that the corrective actions are authorized.

12. The computer program product as recited in claim 11, further comprising:
ninth instructions for testing a component within the distributed data processing system and utilized in conjunction with the director service to determine whether the component is functioning properly if it is determined that an error is not found after querying the directory service objects for errors;
tenth instructions for consulting a knowledge base to determine if an entry for the error is contained within the knowledge base if it is determined that an error exists preventing the component from functioning properly;
eleventh instructions for determining corrective actions to be taken to correct the error and determining whether the corrective actions are authorized under present conditions of the distributed data processing system if it is determined that an entry for the error is contained within the knowledge base; and
twelfth instructions for committing the corrective actions if it is determined that the corrective actions are authorized.

13. A system for monitoring a directory service in a distributed data processing system, the system comprising:
first means for scanning event logs for components and applications utilized by a directory service within a distributed data processing system;
second means for consulting a knowledge base to determine if an entry for the error is contained within the knowledge base if it is determined that an error is indicated by one of the event logs, wherein the knowledge base contains entries for known errors and associated corrective actions;
third means for determining corrective actions to be taken to correct the error and determining whether the corrective actions are authorized under present conditions of the distributed data processing system if it is determined that an entry for the error is contained within the knowledge base; and
fourth means for committing the corrective actions if it is determined that the corrective actions are authorized.

14. The system as recited in claim 13, further comprising:
fifth means for paging support personnel if it is determined that the corrective action is not authorized;
sixth means for logging relevant information related to the error; and
seventh means for providing a report concerning the error to a monitoring console.

15. The system as recited in claim 13, wherein determining the corrective actions comprises consulting a table containing identified errors and associated corrective actions.

16. The system as recited in claim 13, further comprising:
fifth means for paging support personnel if it is determined that the error is not found in the knowledge base;
sixth means for logging relevant information related to the error; and
seventh means for providing a report concerning the error to a monitoring console.

17. The system as recited in claim 13, further comprising:
fifth means for querying directory service objects for errors;
sixth means for consulting a knowledge base to determine whether an entry for the error is contained within the knowledge base if it is determined that an error is found from querying the directory service objects for errors, wherein the knowledge base contains entries for known errors and associated corrective actions;
seventh means for determining corrective actions to be taken to correct the error and determining whether the corrective actions are authorized under present conditions of the distributed data processing system if it is determined that an entry for the error is contained within the knowledge base; and
eighth means for committing the corrective actions if it is determined that the corrective actions are authorized.

18. The system as recited in claim 17, further comprising:
ninth means for testing a component within the distributed data processing system and utilized in conjunction with the director service to determine whether the component is functioning properly if it is determined that an error is not found after querying the directory service objects for errors;
tenth means for consulting a knowledge base to determine if an entry for the error is contained within the knowledge base if it is determined that an error exists preventing the component from functioning properly;
eleventh means for determining corrective actions to be taken to correct the error and determining whether the corrective actions are authorized under present conditions of the distributed data processing system if it is determined that an entry for the error is contained within the knowledge base; and
twelfth means for committing the corrective actions if it is determined that the corrective actions are authorized.
